(19) United States
(12) Patent Application Publication
(10) Pub. No.: US 2022/0179617 A1
(43) Pub. Date: Jun. 9, 2022

(54) VIDEO DEVICE AND OPERATION METHOD THEREOF

(71) Applicant: Wistron Corp., New Taipei City (TW)

(72) Inventors: Ching-Ping CHEN, New Taipei City (TW); Wi Duk OH, New Taipei City (TW)

(21) Appl. No.: 17/169,114

(22) Filed: Feb. 5, 2021

(30) Foreign Application Priority Data
Dec. 4, 2020 (TW) 109142724

(51) Int. Cl. G06F 3/16; G06F 3/01; G10L 17/22; G10L 25/57

(52) U.S. Cl. CPC G06F 3/167; G10L 25/57; G10L 17/22; G06F 3/017

(57) ABSTRACT

A video device includes an image-capturing device, an image analysis device, a voice-capturing device, a voice-identification device and a processing device. The image-capturing device captures an image. The image analysis device analyzes the image to generate a voice-identification start command. The voice-capturing device captures a voice. The voice-identification device identifies the voice according to the voice-identification start command and generates a voice command. The processing device adjusts the operation of the video device according to the voice command. Therefore, convenience of use may be effectively increased.

### CROSS REFERENCE TO RELATED APPLICATIONS

This application claims priority of Taiwan Patent Application No. 109142724, filed on Dec. 4, 2020, the entirety of which is incorporated by reference herein.

### BACKGROUND OF THE INVENTION

### Field of the Invention

An embodiment of the present invention relates to a video device, and in particular it relates to a video device and an operation method thereof.

### Description of the Related Art

Generally, in order to facilitate the use of a video-meeting product in a meeting room, the user may need to use the functions of the video-meeting product, such as mute function, volume adjustment, etc. However, the above functions may require the user to manually press a button, and the people present during the meeting may be seated far enough away from the console of the video-meeting product that this would be inconvenient.

In view of this, some video-meeting products may use voice control to perform the mute function or volume adjustment. However, voice control requires that the user first use call a wake-up word, such as “Alexa”, “Ok google”, etc., in order to wake up the voice control system of the video-meeting product. Then, the voice control system sends the voice information to the cloud to have the cloud identify the voice information, and the video control system may then perform the mute function or the volume adjustment according to the identification result from the cloud. However, if the wake-up word is used in the course of the conversation, it may cause trouble during the meeting. Therefore, the video-meeting product still needs improvement.

### BRIEF SUMMARY OF THE INVENTION

An embodiment of the present invention provides a video device and an operation method thereof, thereby using image identification to achieve the operation of voice control, so as to effectively increase the convenience of use.

An embodiment of the present invention provides a video device, which includes an image-capturing device, an image analysis device, a voice-capturing device, a voice-identification device and a processing device. The image-capturing device is configured to capture an image. The image analysis device is coupled to the image-capturing device, and configured to receive the image, and analyze the image to generate a voice-identification start command. The voice-capturing device is configured to capture a voice. The voice-identification device is coupled to the voice-capturing device and the image analysis device. The voice-identification device is configured to receive the voice and the voice-identification start command. The voice-identification device is configured to identify the voice according to the voice-identification start command to generate a voice command. The processing device is coupled to the image analysis device and the voice-identification device. The processing device is configured to receive the voice command. The processing device is configured to adjust the operation of the video device according to the voice command.

In addition, an embodiment of the present invention provides an operation method of a video device, which includes the following steps. A voice-capturing device is used to capture a voice. An image-capturing device is used to capture an image. An image analysis device is used to receive the image, and analyze the image to generate a voice-identification start command. A voice-identification device is used to receive the voice and the voice-identification start command. The voice-identification device is used to identify the voice according to the voice-identification start command to generate a voice command. A processing device is used to receive the voice command. The processing device is used to adjust the operation of the video device according to the voice command.

According to the video device and the operation method thereof disclosed by the embodiment of the present invention, the image analysis device analyzes the image to generate a voice-identification start command. The voice-identification device identifies the voice according to the voice-identification start command to generate the voice command. The processing device adjusts the operation of the video device according to the voice command. Therefore, the image identification may be used to achieve the operation of voice control, so as to effectively increase the convenience of use.

### BRIEF DESCRIPTION OF THE DRAWINGS

The present invention can be more fully understood by reading the subsequent detailed description and examples with references made to the accompanying drawings, wherein:

FIG. 1 is a schematic view of a video device according to an embodiment of the present invention;

FIG. 2 is a schematic view of a video device according to an embodiment of the present invention;

FIG. 3 is a flowchart of an operation method of a video device according to an embodiment of the present invention;

FIG. 4 is a detailed flowchart of step S304 in FIG. 3;

FIG. 5 is a detailed flowchart of step S402 and step S404 in FIG. 4;

FIG. 6 is a flowchart of an operation method of a video device according to another embodiment of the present invention; and

FIG. 7 is a flowchart of an operation method of a video device according to another embodiment of the present invention.

### DETAILED DESCRIPTION OF THE INVENTION

In each of the following embodiments, the same reference number represents the same or similar element or component.

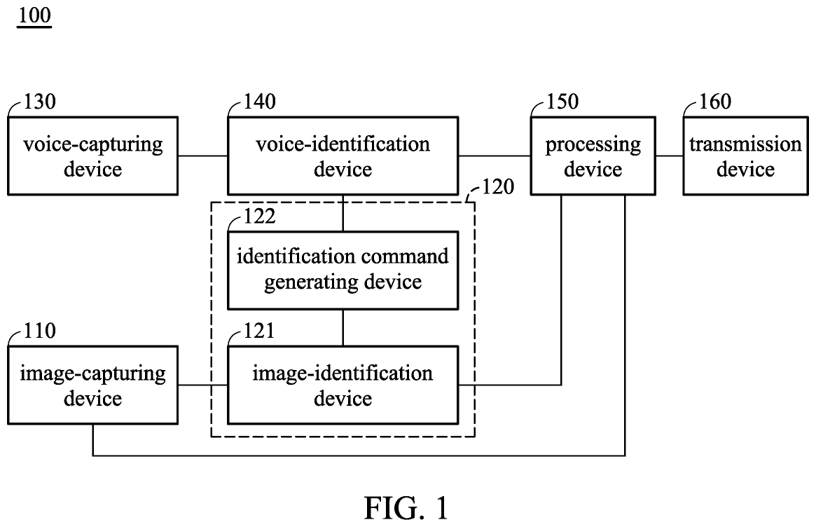

FIG. 1 is a schematic view of a video device according to an embodiment of the present invention. In the embodiment, the video device 100 is suitable for indoor space where video is performed, such as a meeting room, but the embodiment of the present invention is not limited thereto. Please refer to FIG. 1. The video device 100 includes an image-capturing device 110, an image analysis device 120, a voice-capturing device 130, a voice-identification device 140 and a processing device 150.

The image-capturing device 110 captures an image. For example, the image-capturing device 110 performs an image-capturing operation on an object or a body (for example, the user participating in a videoconference) to capture the corresponding image. In the embodiment, the image-capturing device 110 may be a charge coupled device (CCD), a 360-degree panoramic camera or other camera with image capturing function, but the embodiment of the present invention is not limited thereto.

The image analysis device 120 is coupled to the image-capturing device 110. The image analysis device 120 receives the image, and analyzes the image to generate a voice-identification start command. For example, the image analysis device 120 may analyze the image to determine whether the image includes a predetermined motion, so as to generate the voice-identification start command. In the embodiment, the above predetermined motion may be a gesture, such as raising a hand, waving, or another specific gesture, but the embodiment of the present invention is not limited thereto.

That is, when the image analysis device 120 determines that the image includes the predetermined motion, the image analysis device 120 may generate the voice-identification start command. When the image analysis device 120 determines that the image does not include the predetermined motion, the image analysis device 120 does not generate the voice-identification start command. In addition, regardless of whether the image includes or does not include the predetermined motion as determined by the image analysis device 120, the image analysis device 120 may transmit the received image to the processing device 150.

Furthermore, the image analysis device 120 may include an image-identification device 121 and an identification command generating device 122. The image-identification device 121 is coupled to the image-capturing device 110. The image-identification device 121 may receive the image and identify whether the image includes a predetermined motion, so as to generate an identification result. When identifying that the image includes the predetermined motion, the image-identification device 121 may generate the identification result in response to the image including the predetermined motion. When identifying that the image does not include the predetermined motion, the image-identification device 121 does not generate the identification result in response to the image not including the predetermined motion.

The identification command generating device 122 is coupled to the image-identification device 121 and the voice-identification device 140, receives the identification result, and generates the voice-identification start command according to the identification result. For example, when the identification command generating device 122 receives the identification result, the identification command generating device 122 may generate the voice-identification start command in response to the identification result being received. When the identification command generating device 122 does not receive the identification result, the identification command generating device 122 does not generate the voice-identification start command in response to the identification result not being received.

The voice-capturing device 130 captures a voice. For example, the voice-capturing device 130 may perform a capturing operation on the voice (such as user speech) emitted by the object or the body in indoor space to capture the corresponding voice. In the embodiment, the voice-capturing device 130 may be a microphone array, a directional microphone or other devices with voice capturing function, etc., but the embodiment of the present invention is not limited thereto.

The voice-identification device 140 is coupled to the voice-capturing device 130 and the image analysis device 120. In the embodiment, the voice-identification device 140 may be a digital signal processor (DSP), but the embodiment of the present invention is not limited thereto. The voice-identification device 140 receives the voice and the voice-identification start command. The voice-identification device 140 identifies the voice according to the voice-identification start command, so as to generate a voice command. For example, when the voice-identification device 140 receives the voice-identification start command, the voice-identification device 140 starts to identify the voice to determine whether the voice includes words related to adjusting the operation of the video device 100, such as volume up, volume down, mute, power-off, etc.

When the voice-identification device 140 determines that the voice includes words related to adjusting the operation of the video device 100, the voice-identification device 140 may generate a voice command that includes an operating instruction. When the voice-identification device 140 determines that the voice does not include any words related to adjusting the operation of the video device 100, the voice-identification device 140 does not generate a voice command, and the voice-identification device 140 may transmit the voice to the processing device 150. In addition, when the voice-identification device 140 does not receive the voice-identification start command, the voice-identification device 140 does not identify the voice, and the voice-identification device 140 transmits the voice to the processing device 150.

The processing device 150 is coupled to the image analysis device 120 and the voice-identification device 140. In the embodiment, the processing device 150 may be a central processing unit (CPU), a micro-processor, or a micro control unit (MCU), but the embodiment of the present invention is not limited thereto. The processing device 150 may receive the voice command, and adjust the operation of the video device 100 according to the voice command. That is, when the processing device 150 receives the voice command, the processing device may adjust the operation of the video device 100 according to an operation instruction corresponding to the voice command.

For example, when the operation instruction corresponding to the voice command is the volume up, the processing device 150 adjusts the volume of a speaker or a sound box of the video device 100 to up according to the above voice command. When the operation instruction corresponding to the voice command is the volume down, the processing device 150 adjusts the volume of the speaker or the sound box of the video device 100 to down according to the above voice command.

When the operation instruction corresponding to the voice command is mute, the processing device 150 sets the volume of the speaker of the sound box of the video device 100 to mute according to the above voice command. When the operation instruction corresponding to the voice command is to turn the system off, the processing device 150 performs an operation that turns off the video device 100, thereby avoiding situations where the user forgets to turn off the video device 100 after the video is over, as this may result in a waste of power.

In some embodiments, the processing device 150 may further be coupled to the image-capturing device 110. The processing device 150 may generate a control signal to the image-capturing device 110 according to the voice, such that the image-capturing device 110 focuses on the source of the voice according to the control signal. That is, the processing device 150 may receive the voice from the voice-identification device 140, and analyze the voice to determine the source of the voice, i.e., the location of the speaking user.

Then, after the processing device 150 determines the source of the voice, the processing device 150 may generate the control signal to the image-capturing device 110, such that the image-capturing device 110 focuses (for example, digital focus) on the source of the voice according to the control signal, i.e., the image-capturing device 110 may focus on the speaking user.

Therefore, the image-capturing device 110 may capture the image from the source of the voice, increasing the accuracy of the image analysis device's 120 (the image-identification device 121) analysis (identification) of the image. In addition, this avoids situations in which another user inadvertently makes the predetermined motion, causing the image analysis device 120 to generate a voice-identification start command, in turn causing the voice-identification device 140 to identify that voice and then generate a voice command that ultimately results in an unintended operation.

In some embodiments, the video device 100 further includes a transmission device 160. The transmission device 160 may be coupled to the processing device 150, and the transmission device 160 may transmit the voice and the image. For example, the transmission device 160 may transmit the voice to the speaker or the sound box, and transmit the image to the display. In addition, the transmission device 160 may also wired or wirelessly transmit the voice and the image to the remote meeting room to facilitate a video meeting.

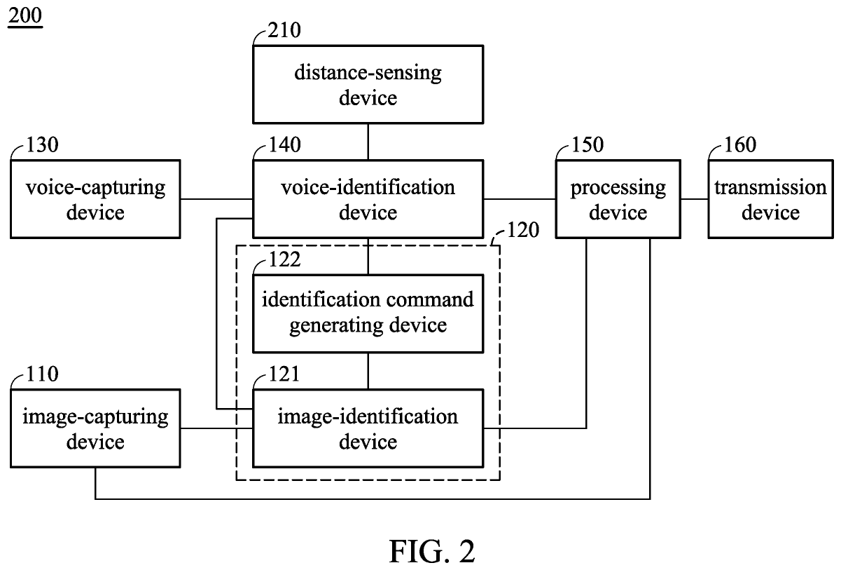

FIG. 2 is a schematic view of a video device according to an embodiment of the present invention. In the embodiment, the video device 200 is also suitable for indoor space where video is performed, such as a meeting room, but the embodiment of the present invention is not limited thereto. Please refer to FIG. 2. The video device 200 includes an image-capturing device 110, an image analysis device 120, a voice-capturing device 130, a voice-identification device 140, a processing device 150, a transmission device 160 and a distance-sensing device 210.

In the embodiment, the image-capturing device 110, the image analysis device 120, the voice-capturing device 130, the voice-identification device 140, the processing device 150 and the transmission device 160 in FIG. 2 are the same as or similar to the image-capturing device 110, the image analysis device 120, the voice-capturing device 130, the voice-identification device 140, the processing device 150 and the transmission device 160 in FIG. 1. The image-capturing device 110, the image analysis device 120, the voice-capturing device 130, the voice-identification device 140, the processing device 150 and the transmission device 160 in FIG. 2 may be refer to the description of the embodiment in FIG. 1, and the description thereof is not repeated herein. In addition, the image-identification device 121 and the identification command generating device 122 included in the image analysis device 120 of the embodiment are also the same as or similar to the image-identification device 121 and the identification command generating device 122 in FIG. 1. The image-identification device 121 and the identification command generating device 122 of the embodiment may refer to the description of the embodiment in FIG. 1, and the description thereof is not repeated herein.

The distance-sensing device 210 is coupled to the voice-identification device 140. The distance-sensing device 210 may sense the distance of an object to generate a distance-sensing signal. In the embodiment, the distance-sensing device 210 may be an infrared image sensor, but the embodiment of the present invention is not limited thereto. In addition, the distance-sensing device 210 has a function of time of flight (ToF).

For example, the distance-sensing device 210 may emit an infrared light to the object (such as the user), and receive a reflected light generated by object reflecting the infrared light. Then, the distance-sensing device 210 may calculate the distance between the distance-sensing device 210 and the object according to an emitting time of emitting the infrared light and a receiving time of receiving the reflected light, so as to generate the corresponding distance-sensing signal. That is, when the difference between the emitting time and the receiving time is small, this means that the distance between the distance-sensing device 210 and the object is short. When the difference between the emitting time and the receiving time is great, this means that the distance between the distance-sensing device 210 and the object is long.

Then, the voice-identification device 140 may also be coupled to the image-identification device 121. The voice-identification device 140 may receive the distance-sensing signal, the image and the voice, and process the voice according to the distance-sensing signal and the image to determine whether the voice is a valid voice source. In the embodiment, the valid voice source may be inside a predetermined distance range and be a human voice source, and an invalid voice source may be outside the predetermined distance range and not be the human voice source (such as an environment voice source or a voice source generated by other devices).

Furthermore, when the voice-identification device 140 determines that the voice is a valid voice source and the voice-identification device 140 receives the voice-identification start command, the voice-identification device 140 may identify the voice according to the voice-identification start command in response to the voice being a valid voice source and the voice-identification start command being received, so as to generate the voice command. In addition, when the voice-identification device 140 determines that the voice is not the valid voice source, the voice-identification device 140 may filter out the voice in response to the voice not being a valid voice source. Therefore, the accuracy of voice-identification may be increased further.

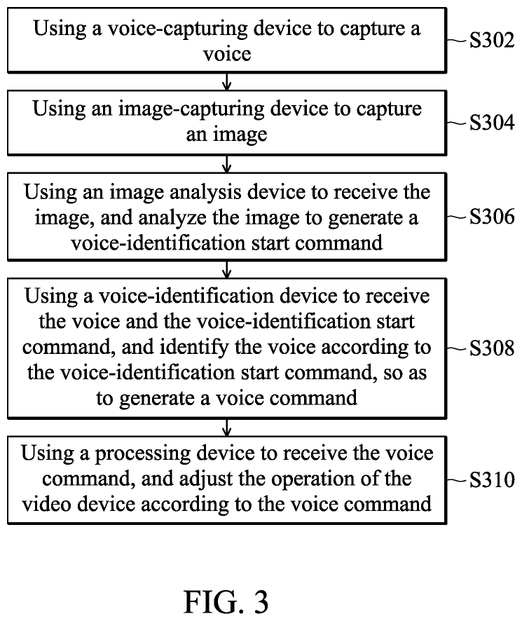

According to the description above, the embodiment of the present invention additionally provides an operation method of a video device. FIG. 3 is a flowchart of an operation method of a video device according to an embodiment of the present invention. In step S302, the method involves using a voice-capturing device to capture a voice. In step S304, the method involves using an image-capturing device to capture an image.

In step S306, the method involves using an image analysis device to receive the image, and analyze the image to generate a voice-identification start command. In step S308, the method involves using a voice-identification device to receive the voice and the voice-identification start command, and identify the voice according to the voice-identification start command, so as to generate a voice command. In step S310, the method involves using a processing device to receive the voice command, and adjust the operation of the video device according to the voice command. In the embodiment, the predetermined motion is a gesture.

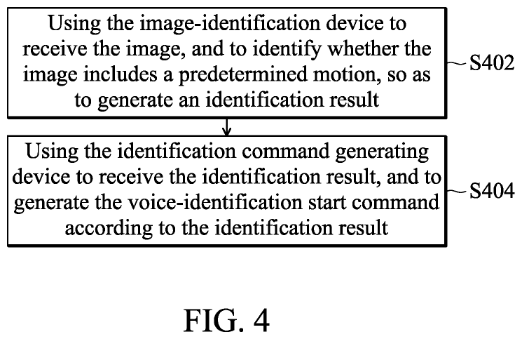

FIG. 4 is a detailed flowchart of step S304 in FIG. 3. In the embodiment, the image analysis device includes an image-identification device and an identification command generating device. In step S402, the method involves using the image-identification device to receive the image, and to identify whether the image includes a predetermined motion, so as to generate an identification result. In step S404, the method involves using the identification command generating device to receive the identification result, and to generate the voice-identification start command according to the identification result.

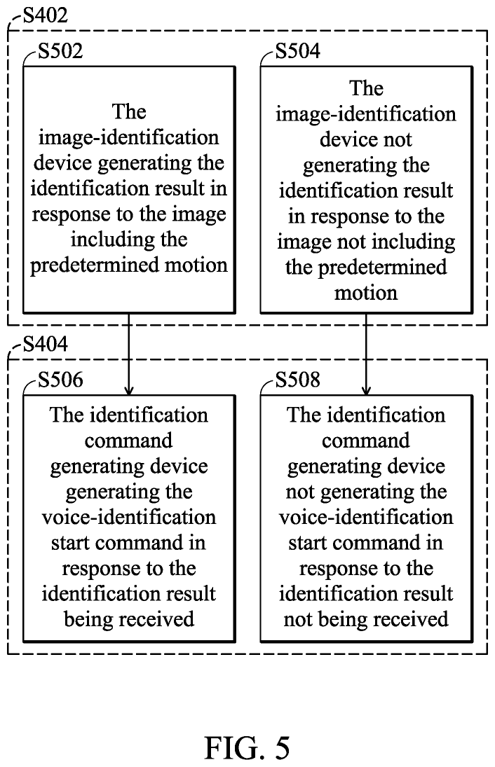

FIG. 5 is a detailed flowchart of step S402 and step S404 in FIG. 4. In step S502, the method involves the image-identification device generating the identification result in response to the image including the predetermined motion. In step S504, the method involves the image-identification device not generating the identification result in response to the image not including the predetermined motion. In step S506, the method involves the identification command generating device generating the voice-identification start command in response to the identification result being received. In step S508, the method involves the identification command generating device not generating the voice-identification start command in response to the identification result not being received.

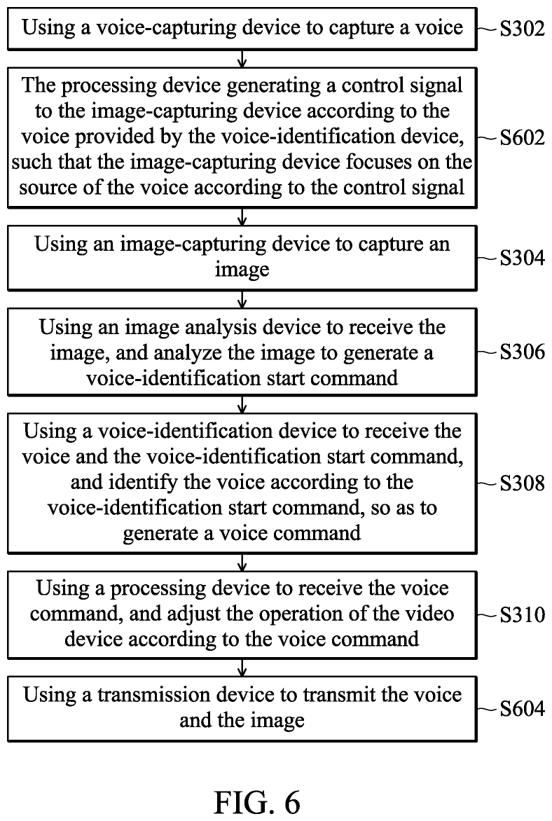

FIG. 6 is a flowchart of an operation method of a video device according to another embodiment of the present invention. In the embodiments, steps S302-S310 in FIG. 6 are the same as or similar to steps S302-S310 in FIG. 3. Step S302-S310 in FIG. 6 may refer to the description of the embodiment in FIG. 3, and the description thereof is not repeated herein.

In step S602, the method involves the processing device generating a control signal to the image-capturing device according to the voice provided by the voice-identification device, such that the image-capturing device focuses on the source of the voice according to the control signal. In step S604, the method involves using a transmission device to transmit the voice and the image.

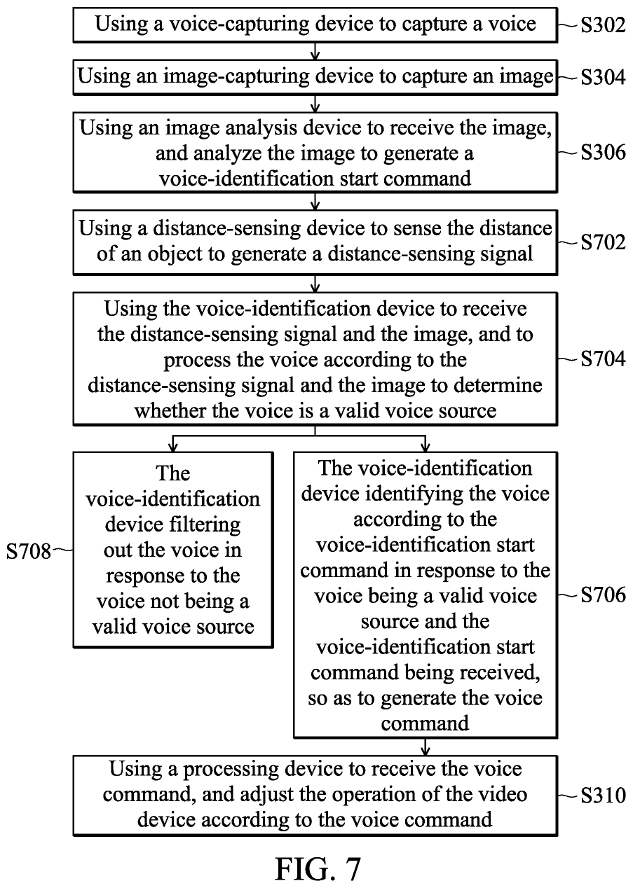

FIG. 7 is a flowchart of an operation method of a video device according to another embodiment of the present invention. In the embodiments, steps S302-S306 and S310 in FIG. 7 are the same as or similar to steps S302-S306 and S310 in FIG. 3. Step S302-S306 and S310 in FIG. 7 may refer to the description of the embodiment in FIG. 3, and the description thereof is not repeated herein.

In step S702, the method involves using a distance-sensing device to sense the distance of an object to generate a distance-sensing signal. In step S704, the method involves using the voice-identification device to receive the distance-sensing signal and the image, and to process the voice according to the distance-sensing signal and the image to determine whether the voice is a valid voice source.

In step S706, the method involves the voice-identification device identifying the voice according to the voice-identification start command in response to the voice being a valid voice source and the voice-identification start command being received, so as to generate the voice command. In step S708, the method involves the voice-identification device filtering out the voice in response to the voice not being a valid voice source.

In one embodiment, the image-capturing device, the image analysis device, the voice-capturing device, the voice-identification device and the processing device may be implemented in hardware, code (such as software or firmware) executed by a processor, or any combination thereof. If the above devices are implemented in the code executed by the processor, the functions of the above devices or the sub-components thereof may be performed by a general-purpose processor, a DSP, an application specific integrated circuit (ASIC), a FPGA, or other programmable logic device, individual gate or transistor logic, individual hardware component, or any combination thereof that is designed to perform the functions described in the present invention.

In summary, according to the video device and the operation method thereof disclosed by the embodiment of the present invention, the image analysis device analyzes the image to generate the voice-identification start command, and the voice-identification device identifies the voice according to the voice-identification start command to generate the voice command, such that the processing device adjusts the operation of the video device according to the voice command. Therefore, the image identification may be used to achieve the operation of voice control, so as to effectively increase the convenience of use.

In addition, the processing device may further generate the control signal to the image-capturing device according to the voice provided by the voice-identification device, such that the image-capturing device focuses on the source of the voice according to the control signal. Therefore, the accuracy of the image analysis device's analysis of the image may be increased, avoiding situations in which another user inadvertently makes the predetermined motion, causing the image analysis device to generate a voice-identification start command, in turn causing the voice-identification device to identify that voice and then generate a voice command that ultimately results in an unintended operation. Furthermore, the embodiment of the present invention may further use a distance-sensing device to sense the distance of the object, so as to generate the distance-sensing signal. The voice-identification device may further receive the distance-sensing signal, the image, and the voice, and process the voice according to the distance-sensing signal and the image to determine whether the voice is a valid voice source. Therefore, the accuracy of voice-identification may be increased further.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video device, comprising:
an image-capturing device, configured to capture an image;
an image analysis device, coupled to the image-capturing device, and configured to receive the image, and analyze the image to generate a voice-identification start command;
a voice-capturing device, configured to capture a voice;
a voice-identification device, coupled to the voice-capturing device and the image analysis device, and configured to receive the voice and the voice-identification start command, and identify the voice according to the voice-identification start command, so as to generate a voice command; and
a processing device, coupled to the image analysis device and the voice-identification device, and configured to receive the voice command, and adjust an operation of the video device according to the voice command.

2. The video device as claimed in claim 1, wherein the image analysis device comprises:
an image-identification device, coupled to the image-capturing device, and configured to receive the image, and to identify whether the image comprises a predetermined motion, so as to generate an identification result; and
an identification command generating device, coupled to the image-identification device and the voice-identification device, and configured to receive the identification result, and to generate the voice-identification start command according to the identification result.

3. The video device as claimed in claim 2, wherein the image-identification device generates the identification result in response to the image comprising the predetermined motion, and the image-identification device does not generate the identification result in response to the image not comprising the predetermined motion.

4. The video device as claimed in claim 3, wherein the identification command generating device generates the voice-identification start command in response to the identification result being received, and the identification command generating device does not generate the voice-identification start command in response to the identification result not being received.

5. The video device as claimed in claim 2, wherein the predetermined motion is a gesture.

6. The video device as claimed in claim 1, wherein the processing device is further coupled to the image-capturing device, the processing device further generates a control signal to the image-capturing device according to the voice provided by the voice-identification device, such that the image-capturing device focuses on a source of the voice according to the control signal.

7. The video device as claimed in claim 1, further comprising:
a distance-sensing device, coupled to the voice-identification device, and configured to sense a distance of an object to generate a distance-sensing signal;
wherein the voice-identification device further receives the distance-sensing signal and the image, and processes the voice according to the distance-sensing signal and the image to determine whether the voice is a valid voice source.

8. The video device as claimed in claim 7, wherein the voice-identification device identifies the voice according to the voice-identification start command in response to the voice being the valid voice source and the voice-identification start command being received, so as to generate the voice command.

9. The video device as claimed in claim 8, wherein the voice-identification device filters out the voice in response to the voice not being the valid voice source.

10. The video device as claimed in claim 1, further comprising:
a transmission device, coupled to the processing device, and configured to transmit the voice and the image.

11. An operation method of a video device, comprising:
using a voice-capturing device to capture a voice;
using an image-capturing device to capture an image;
using an image analysis device to receive the image, and analyze the image to generate a voice-identification start command;
using a voice-identification device to receive the voice and the voice-identification start command, and identify the voice according to the voice-identification start command, so as to generate a voice command; and
using a processing device to receive the voice command, and adjust an operation of the video device according to the voice command.

12. The operation method of the video device as claimed in claim 11, wherein the image analysis device comprises an image-identification device and an identification command generating device, and the step of using the image analysis device to receive the image, and analyze the image to generate the voice-identification start command comprises:
using the image-identification device to receive the image, and to identify whether the image comprises a predetermined motion, so as to generate an identification result; and
using the identification command generating device to receive the identification result, and to generate the voice-identification start command according to the identification result.

13. The operation method of the video device as claimed in claim 12, wherein the step of using the image-identification device to receive the image, and to identify whether the image comprises the predetermined motion, so as to generate the identification result, comprises:
the image-identification device generating the identification result in response to the image comprising the predetermined motion; and
the image-identification device not generating the identification result in response to the image not comprising the predetermined motion.

14. The operation method of the video device as claimed in claim 13, wherein the step of using the identification command generating device to receive the identification result, and to generate the voice-identification start command according to the identification result, comprises:
the identification command generating device generating the voice-identification start command in response to the identification result being received; and
the identification command generating device not generating the voice-identification start command in response to the identification result not being received.

15. The operation method of the video device as claimed in claim 12, wherein the predetermined motion is a gesture.

16. The operation method of the video device as claimed in claim 12, further comprising:
the processing device generating a control signal to the image-capturing device according to the voice provided by the voice-identification device, such that the image-capturing device focuses on a source of the voice according to the control signal.

17. The operation method of the video device as claimed in claim 12, further comprising:
using a distance-sensing device to sense a distance of an object to generate a distance-sensing signal; and
using the voice-identification device to receive the distance-sensing signal and the image, and to process the voice according to the distance-sensing signal and the image to determine whether the voice is a valid voice source.

18. The operation method of the video device as claimed in claim 17, wherein the step of using the voice-identification device to receive the voice and the voice-identification start command and to identify the voice according to the voice-identification start command, so as to generate the voice command comprises:
the voice-identification device identifying the voice according to the voice-identification start command in response to the voice being the valid voice source and the voice-identification start command being received, so as to generate the voice command.

19. The operation method of the video device as claimed in claim 18, further comprising:
the voice-identification device filtering out the voice in response to the voice not being the valid voice source.

20. The operation method of the video device as claimed in claim 11, further comprising:
using a transmission device to transmit the voice and the image.
